(19) United States
(12) Patent Application Publication
(10) Pub. No.: US 2018/0353870 A1
(43) Pub. Date: Dec. 13, 2018

(54) Edible Pneumatic Soft Robotic Actuators

(71) Applicant: The Haverford School, Haverford, PA (US)

(72) Inventors: Matthew Noah Baumholtz, Wynnewood, PA (US); Richard Buonocore, Newtown Square, PA (US); Yiheng Chen, Bryn Mawr, PA (US); Holly Golecki, Ardmore, PA (US); Aditya N. Sardesai, Blue Bell, PA (US); Xavier Matthew Segel, Newtown Square, PA (US); Bram Winter Schork, Villanova, PA (US); Ruhao Sun, Ardmore, PA (US); Kyle Oming Wagner, Chester Springs, PA (US); William Henry Baltrus, East Norriton, PA (US); Graham Harrison Haabestad, Newtown Square, PA (US)

(21) Appl. No.: 15/967,980

(22) Filed: May 1, 2018

Related U.S. Application Data
(60) Provisional application No. 62/517,299, filed on Jun. 9, 2017.

(51) Int. Cl. A63H 9/00; A23G 4/10; A23G 4/14; A63H 13/00; A63H 29/16

(52) U.S. Cl. CPC A63H 9/00; A23G 4/10; A23P 30/10; A63H 13/00; A63H 29/16; A23G 4/14

(57) ABSTRACT

The present invention relates to a biocompatible, digestible and edible material for use in soft edible robots. The present invention provides a pneumatic actuator for edible robotics, and a toy set including at least one pneumatic actuator and an inflating device. Further, the biocompatible, digestible and edible material can be used for making bubble gum products.

### FIELD OF INVENTION

This invention relates to a biocompatible and digestible material, a method of preparing the biocompatible and digestible material, and an edible pneumatic soft robotic actuators.

### BACKGROUND OF THE INVENTION

Robotics is a field of enormous and ever growing importance. Most robotic systems are “hard”, i.e., composed of metallic structures with joints based on conventional bearings. In an effort to expand the range of environments in which the robot operates, soft robotics has become an area of significant interest in recent years.

One of the challenges facing soft robotics is the material because the functionalities and applications of the soft robot are to a large extent limited by the mechanical, physical and chemical properties of the material of choice. For medical soft robots, materials that are compliant, biodegradable, biocompatible, and of no or very low levels of toxicity are of a paramount value. Additionally, certain medical treatment scenarios have presented the need for edible robots.

The requirements for materials used for edible robots are even more stringent than those for non-edible robots. Above all, the materials must be safe for human consumption. All other general requirements for soft robotic materials related to mechanical, physical and chemical properties still apply. Materials of a food origin are preferable.

Soft actuators, especially those pneumatically driven, have been widely developed and applied in various robotic applications. The inventors embarked on developing edible soft pneumatic actuators that can be utilized in edible robots.

### SUMMARY OF THE INVENTION

The present invention provides a biocompatible, digestible and edible material for use in soft edible robots. The biocompatible, digestible and edible material of the current invention is a gelatin and corn syrup composite made from the low cost and readily available gelatin and corn syrup.

The present invention provides a method of fabricating a biocompatible, digestible and edible material for use in soft edible robots.

The present invention provides a pneumatic actuator for edible robotics.

The present invention further provides a toy set comprising at least one pneumatic actuator and an inflating device.

### DESCRIPTION OF THE DRAWINGS

FIG. 1 is a hollowed out gummy bear attached to a syringe.

FIG. 2 is a pneumatic actuator made of gummy bear material.

FIG. 3 is a scheme of melting and molding gummy bear material for preparing actuators.

FIG. 4 shows melting and molding the gummy bear material to furnish the desired pneunets actuators.

FIG. 5 are photographs of the pneunets actuators prepared from gummy bear material.

FIG. 6 is a graph of mechanical compression test results of Samples 2-4.

FIG. 7 is a graph of mechanical stress test results of Samples 3 and 3.1-3.4.

FIG. 8 show a 3D printed mold used to cast a pneumatic actuator.

FIG. 9 shows 3D printed molds used to cast pneumatic actuators.

FIG. 10 is a photograph of a FORDmula actuator.

FIG. 11 is photographs of FORDmula actuators in various shapes in an uninflated or an inflated state.

FIG. 12 is a graph of mechanical stress test results of the pre-fabricated FORDmula gelatin and corn syrup composite, the untreated gummy bear material, and the melted gummy bear material after 3 days of curing.

FIG. 13 are photographs of a pull test of a FORDmula actuator (top: unpulled state; bottom: pulled state).

FIG. 14 are photographs of a pull test of a gelatin actuator (top: unpulled state; bottom: pulled state).

FIG. 15 is a photograph of molded corn syrup after air drying overnight.

FIG. 16 are photographs of degradation test results of a gummy bear actuator and a FORDmula actuator.

FIG. 17 is a graph showing weight of the remaining actuators in a degradation test.

### DETAILED DESCRIPTION OF THE INVENTION

One of the inventors' objectives is to provide a material for edible soft body robotic devices. Such materials need to meet the following criteria: compliant, safe for oral consumption, elastic, extensible, and degradable under physiological conditions.

A gelatin hydrogel actuator immersed in NaOH solution has been reported. As a proof of concept, the inventors first turned to gelatin which is a translucent, colorless, brittle (when dry), flavorless food derived from collagen obtained from various animal body parts. Chemically, gelatin is a mixture of peptides and proteins produced by partial hydrolysis of collagen extracted from the skin, bones, and connective tissues of animals.

### Gummy Bear Actuators

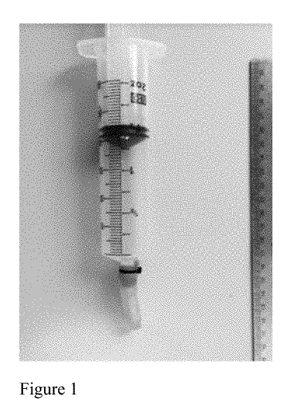

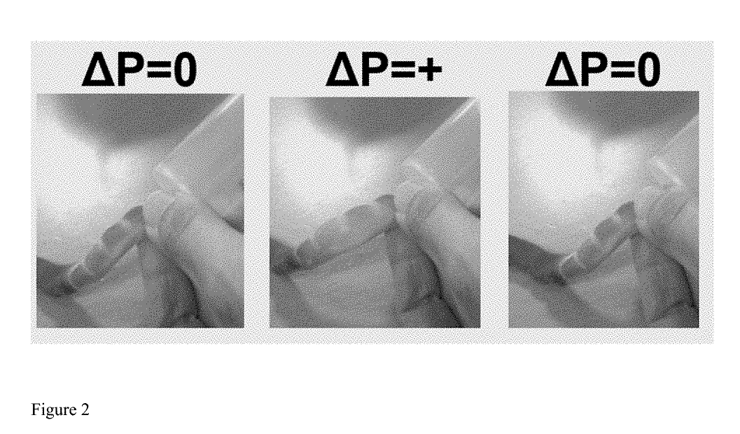

A convenient source of gelatin is the commercial gummy bears. The first question to address is whether the gummy bear material has the elastic properties to be used successfully in an actuator. The inventors purchased the gummy worms from a local grocery store. To hollow out the worms, the inventors used a Wilton brand cookie flooding etching tool (https://www.amazon.com/Wilton-409-7722-Cookie-Flooding-Decorating/dp/B01DUS67X2/ref=sr_1_1?ie=UTF8&qid=1496190942&sr=8-1&keywords=cookie+decorating+etching+tool) to bore a hole through the gummy worm. However, the inside of the gummy worms was self-healing and the hollowed chamber collapsed. With the aid of flour on the tip of the etching tool, the self-healing problem was overcome. A syringe was then attached to the tip opening of the chambered gummy worm. See FIG. 1. The chamber was then inflated. The gummy bear material withstood repeated inflation and deflation. FIG. 2 shows the gummy bear in an initial uninflacted state, a subsequent inflated state, and then a deflated final state.

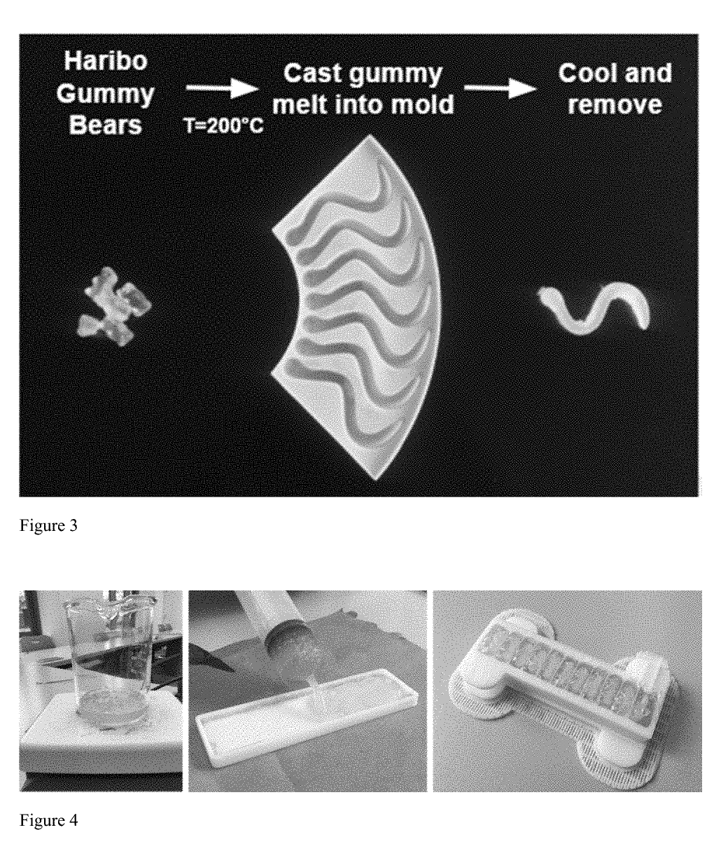

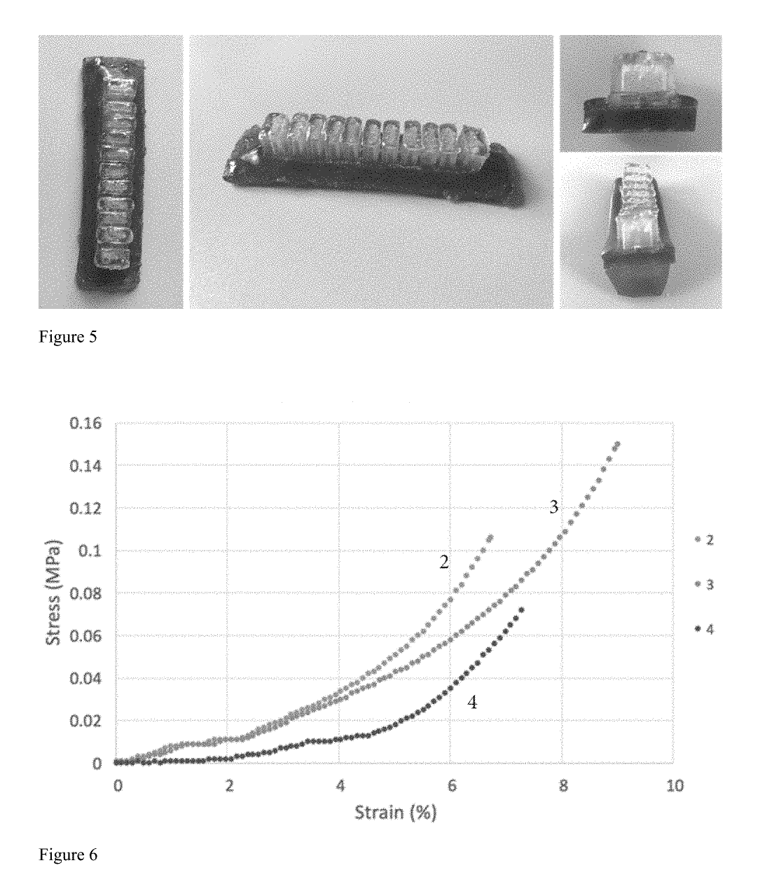

Because of the difficulty in chamber boring, the inventors investigated molding melted gummy bear materials to provide chambered actuators. A general procedure is demonstrated in FIG. 3. The gummy bears were melted on a hot plate, the melt was transferred into a syringe and then cast into a mold to furnish the desired pneunets actuators. See FIG. 4. During the curing process under ambient humidity, dessicants were used to expedite the drying from seven days to one day. See FIG. 5 for the molded pneunets actuators.

Although the gummy bear material provided pneunets actuators as a proof of concept initial exploration, the elasticity property and process difficulties may prevent the material from being of practical value.

### The FORDmula

To improve the elasticity and process, the inventors experimented with the following formulas:

| | H₂O | Corn | Gelatin | |
|---|---|---|---|---|
| Label | (mL) | Syrup (mL) | (g) | Qualitative Analysis |
| 1 | 10 | 10 | 7.2 | Globby/Glue-like/ |
| | | | | (Untestable) |
| 2 | 15 | 15 | 7.2 | Very Elastic/Tear |
| | | | | Resistant/Viscous |
| 3 | 20 | 20 | 7.2 | Elastic/Tear |
| | | | | Resistant/Pourable |
| 4 | 30 | 30 | 7.2 | Elastic/Easily Torn/ |
| | | | | Low Viscosity |

The mechanical properties of samples 2-4 are shown in FIG. 6. Compression tests were performed on an MTS Insight Electromechanical Testing System (2 KN, standard length). Compression tests were performed using a 100 Newton load cell compressing samples of approximate 2 cm by 2 cm in cross section and 0.8 cm in height. Other parameters: compression test rate 0.5 mm/s; data acquired at 10 Hz; and at maximum 10% strain.

Sample 1 was not tested as its globby and uneven properties rendered it untestable. Sample 2 was the most stiff but was much too viscous to properly pour into the mold. Sample 4 was the most elastic. On balance, Sample 3 had the best properties.

To further fine tune the formulation, the inventors experimented with the following formulas:

| | | Corn Syrup | | H₂O/Corn |
|---|---|---|---|---|
| | H₂O | (mL)/Corn | Gelatin | Syrup/Gelatin |
| Sample | (mL) | Syrup (g) * | (g) | by weight |
| 3.1 | 30 | 10/13.3 | 7.2 | 4.2/1.85/1 |
| 3.2 | 25 | 15/19.9 | 7.2 | 3.5/2.77/1 |
| 3 | 20 | 20/26.7 | 7.2 | 2.7/3.71/1 |
| 3.3 | 15 | 25/33.2 | 7.2 | 2.1/4.62/1 |
| 3.4 | 10 | 30/39.9 | 7.2 | 1.4/5.5/1 |

* Light corn syrup has a density of 1.33 g/mL according to
https://www.stevespanglerscience.com/lab/experiments/seven-layer-density-column/

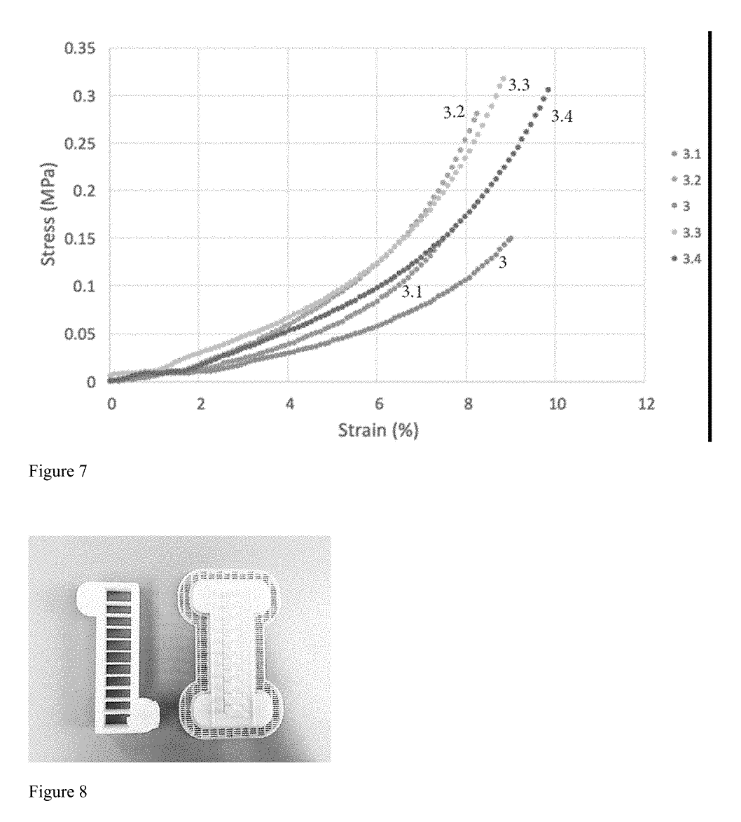

With an increasing amount of water, the composite became visually clearer but weaker in tensile strength. Nevertheless, the composites were all satisfactory in terms of elasticity and mechanical strength. The mechanical properties of the samples are shown in FIG. 7. The overall differences were minimal. The inventors affectionately refer to the formulation giving rise to the gelatin-corn syrup composite of the current invention as “the FORDmula” (“The Fords” is a nick name for Haverford School students).

The inventors chose sample 3.2 for actuator fabrication for several reasons. First, sample 3.2 has a superior elastic property as shown in FIG. 7. Second, the sample has a visual appeal due to its clarity. Samples with higher corn syrup concentrations have a murky appearance that detracts from visual appeal. Third, the sample had a good tensile strength so that it was not too strong and hard to tear thus making it amenable to chewing. Given the desired mechanical properties for materials used in edible soft body devices, sample 3.2 embodies a balance of elasticity and tensile strength. The biocompatible, digestible and edible material of the current invention is a gelatin and corn syrup composite made from the low cost and readily available gelatin and corn syrup.

### Actuator Fabrication

For ease of discussion, the steps of preparing the gelatin-syrup composite and fabricating the actuator using sample 3.2 as an example are combined below:

Step 1: Measure out 25 mL of distilled water in a graduated cylinder and pour it into a 250 mL beaker.

Step 2: Measure out 15 mL of Karo Light Corn Syrup in a graduated cylinder and pour it into the 250 mL beaker used in Step 1. The viscous nature of the syrup will make it stick to the graduated cylinder so be patient.

Step 3: Using a stir rod, stir the liquids together until a uniform solution is formed.

Step 4: Add one 7.2 gram packet of Knox unflavored cooking gelatin into the beaker. Stir the mixture until it becomes uniform and there are no more white gelatin clumps. At this step optionally add any flavoring (Jello sugar packets) or any preferred food coloring.

Step 5: Place the beaker on a hot plate set at 150° C. and let the solution sit on the hot plate for fifteen minutes until a murky top layer and a clear bottom layer forms.

Step 6: Remove the beaker from the hot plate without stirring the solution to avoid mixing of the layers. Let the solution cool for at least on hour.

Step 7: The solution should be one semi-solid mass resembling Jello. Remove the continuous piece from the beaker while wearing gloves. Using a pair of scissors, trim the murky layer off the piece so there is only the clear layer remaining. Now place the gelatin and corn syrup composite into a clean new beaker. The top layer may be excess materials that are not taken in by the amount of water used. It is possible that with an adjustment of the amount of water there may only be one uniform layer. In such a case, no trimming may be necessary.

Step 8: Place the beaker back on the 150° Celsius hot plate and wait for the composite to completely melt.

Step 9: Pour the melted solution from the beaker into a syringe and slowly squirt it into the top mold and bottom mold. Leave enough solution in the beaker for attaching the two parts later.

Step 10: Leave the mold undisturbed for about one hour.

Step 11: Use the rest of the melted solution and pour it into another syringe. Carefully and quickly squirt the melted solution on the bottom of the top mold. Follow the edges and make sure not to fill the air channels. Place the top mold on the bottom mold and wait for them to adhere. You may also squirt some solution along the edges/seams of the actuator to ensure a better seal.

Although the cooling period of step 6 can be as short as one hour, overnight cooling is typical. The length of the cooling period does not appear to significantly affect the properties of the gelatin and corn syrup composite. Also, the length of elapsed time between steps 7 and 8 is not critical since under ambient conditions the mechanical properties of the gelatin and corn syrup composite are well retained. Further, no additional curing is necessary after the actuators are cast.

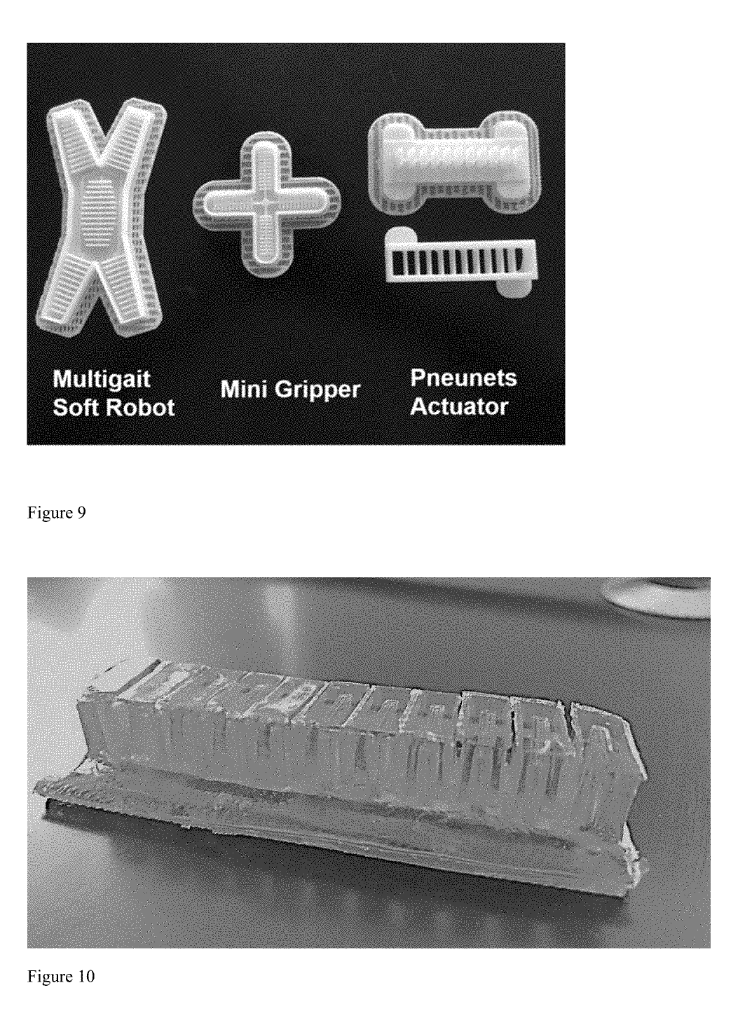

The molds used for the actuator casting were prepared using a 3D printer. See FIGS. 8 and 9. An actuator made of FORDmula composite is shown in FIG. 10.

### Actuator Performance

The gelatin-corn syrup composite and the FORDmula actuators of the current invention are superior in the following aspects: elasticity, tensile strength, and structural integrity under physiological conditions.

1. Elasticity

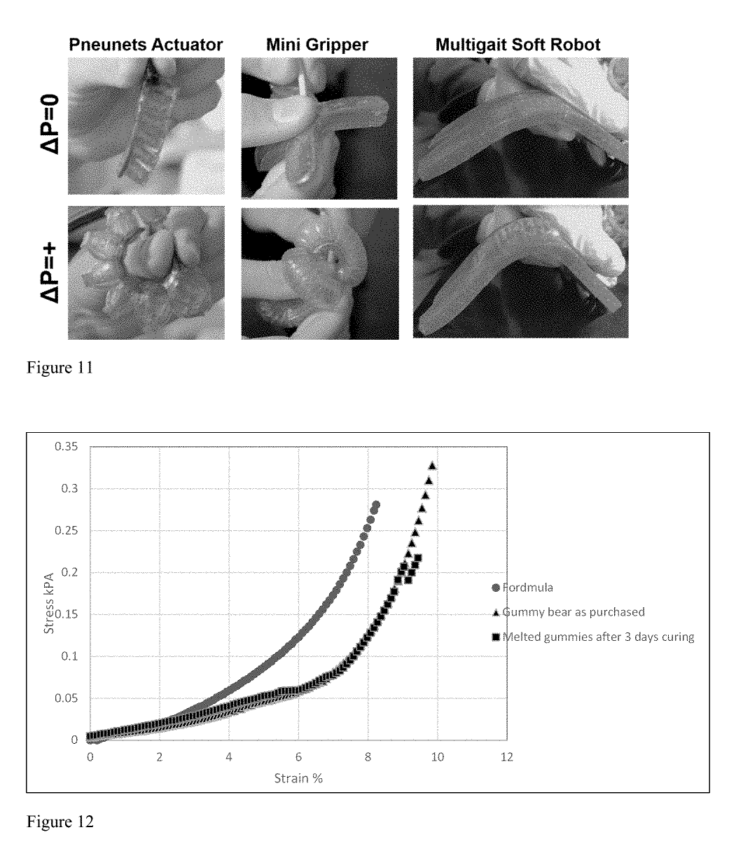

As mentioned above, the elastic properties of the gelatin-corn syrup composite of the current invention are demonstrated in FIG. 7. All samples exhibited good elasticity. The actuators made of the gelatin-corn syrup composite of the current invention were subject to repeated inflation-deflation cycles using either a 60 ml syringe and polyurethane or polyvinyl chloride tubing, or a 18V Power Inflator (http://www.homedepot.com/p/Ryobi-18-Volt-ONE-Power-Inflator-Tool-Only-P737/206159256), as an inflation device. The actuators were able to withstand at least 3 cycles in a rapid succession without visible mechanical deterioration in appearance. FIG. 11 shows FORDmula actuators in an uninflated or an inflated state.

In comparison, the actuator made of cast gelatin does not lend itself to elasticity measurements because the material tears easily at the operating tensions. See discussion below on tensile strength.

The superior elastic properties of the pre-fabricated FORDmula gelatin and corn syrup composite are shown in FIG. 12, when compared with the untreated gummy bear material or the melted gummy bear material after 3 days of curing. The gummy bear material or the melted gummy bear material has a lower elasticity than the FORDmula, and therefore the former does not return to its original shape immediately after actuation, while the FORDmula has a high elasticity and returns to its original shape immediately after actuation.

2. Tensile Strength

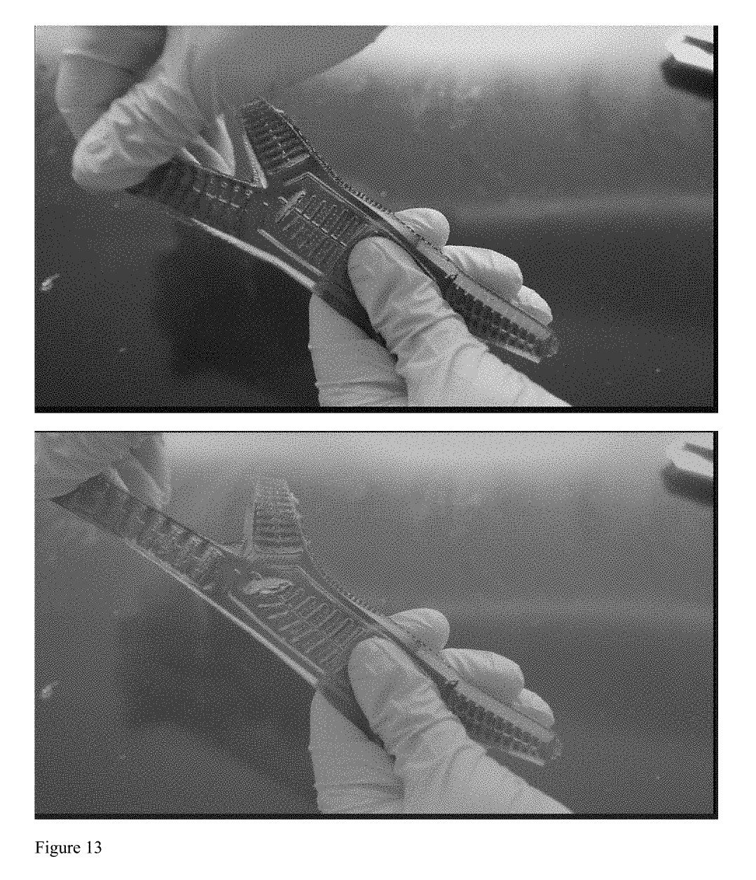

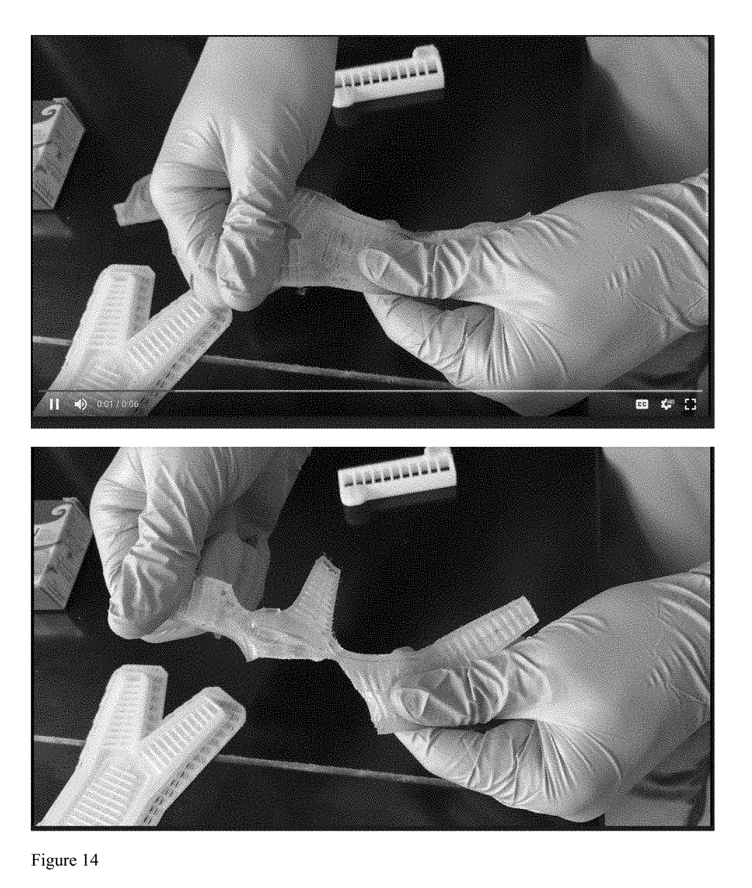

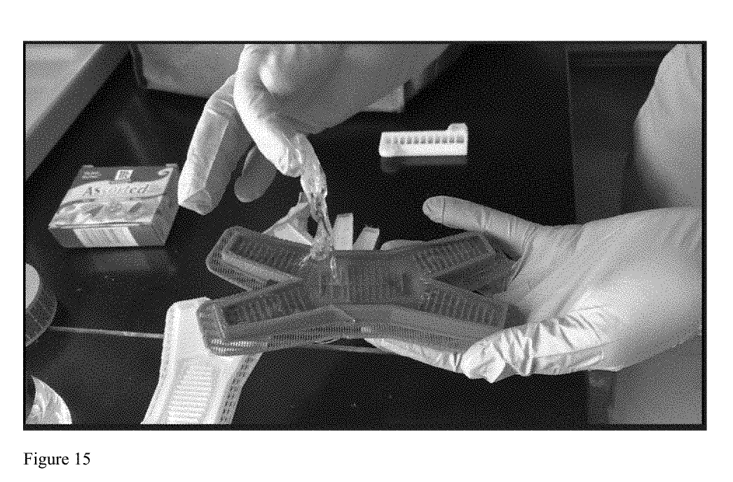

The gelatin-corn syrup composite of the current invention also has good tensile properties compared to the gummy bear material, or gelatin. The FORDmula gelatin and corn syrup composite or actuators do not tear at the relevant operating tensions or pressures. FIG. 13 shows that a FORDmula actuator remains intact upon a pull test (top: original state; bottom: pulled state). In contrast, a gelatin actuator tears when subjected to the same test. In FIG. 14, a gelatin actuator tears at several places when pulled under the same condition. At the same time, corn syrup has no mechanical integrity and cannot stand alone out of the mold as shown in FIG. 15.

3. Structural Integrity

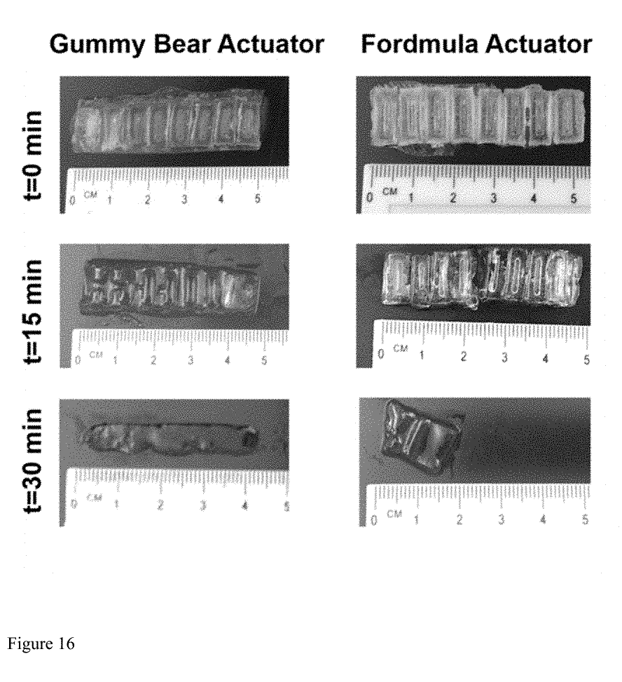

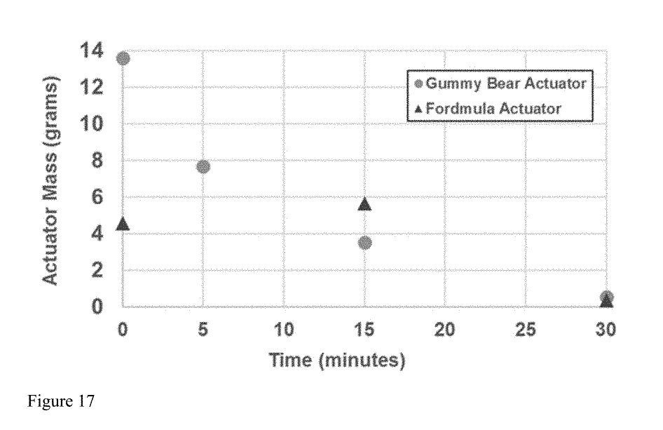

To test the structural integrity of the FORDmula actuators under physiological conditions, the inventors submerged the actuators in a NaCl solution (8 g/L). FIG. 16 is photographs of the actuators at different time points. FIG. 17 reflects the weight of the actuators remaining after being submerged in a NaCl solution. The degradation study shows that the FORDmula Actuators degrade at about the same rate as gummy bear actuators.

The invention provides a soft body robotic device, comprising: (a) a flexible molded body having a plurality of interconnected chambers disposed within the molded body, and a strain limiting portion; and (b) a pressurizing inlet configured to receive a gas for the plurality of interconnected chambers, wherein the soft body robotic device is made of a gelatin and corn syrup composite, and the molded body is configured to preferentially expand when the plurality of interconnected chambers are pressurized by the fluid, causing a bending motion around the strain limiting portion.

### FORDmula Actuator Toy Set

The FORDmula Actuators may be packaged with an inflating device in a toy set to combine the fun of a soft robotic experience with a candy product. The gelatin and corn syrup composite may include color agents and flavor agents to suit the various tastes of its young customer base.

The invention provides a toy set comprising at least one soft body robotic device, and a pressurizing device, wherein the soft body robotic device comprising: (a) a flexible molded body having a plurality of interconnected chambers disposed within the molded body, and a strain limiting portion; and (b) a pressurizing inlet configured to receive a gas for the plurality of interconnected chambers, wherein the soft body robotic device is made of a gelatin and corn syrup composite, and the molded body is configured to preferentially expand when the plurality of interconnected chambers are pressurized by the fluid, causing a bending motion around the strain limiting portion, and wherein the pressurizing inlet is configured to receive the pressurizing device. In one embodiment, the pressurizing device comprises a syringe.

The invention provides a bubble gum product, comprising (a) a flexible molded body having a plurality of interconnected chambers disposed within the molded body, and a strain limiting portion; and (b) a pressurizing inlet configured to receive a gas for the plurality of interconnected chambers, wherein the bubble gum product is made of a gelatin and corn syrup composite, and the molded body is configured to preferentially expand when the plurality of interconnected chambers are pressurized by the fluid, causing a bending motion around the strain limiting portion.

The invention provides a bubble gum product, comprising a gelatin and corn syrup composite produced by a method comprising the steps of: (a) providing a solution of corn syrup in water; (b) mixing gelatin with the solution from step (a) to provide a mixture; (c) heating the mixture from step (b) to about 100° C. to provide a heated mixture, wherein the heated mixture contains a top layer and a bottom layer; (d) cooling the heated mixture from step (c) to provide a mass; and (e) removing a top layer from the mass to provide the gelatin and corn syrup composite. In one embodiment, the gelatin and corn syrup composite is a sheet.

The inventors also envision the FORDmula composite material or the FORDmula Actuators as a bubble gum product. The FORDmula composite material can be processed into a thin sheet of a convenient thickness. In these instances, an inflating device is not needed because the consumer blows up the FORDmula composite sheet or the FORDmula Actuator with his or her mouth as if it is a bubble gum. The superior elasticity and tensile strength of the gelatin and corn syrup composite of the current invention enable multiple actuations within a short period of time.

The description of the present embodiments of the invention has been presented for purposes of illustration, but is not intended to be exhaustive or to limit the invention to the form disclosed. Many modifications and variations will be apparent to those of ordinary skill in the art. As such, while the present invention has been disclosed in connection with an embodiment thereof, it should be understood that other embodiments may fall within the spirit and scope of the invention.

1. A gelatin and corn syrup composite produced by a method comprising the steps of:
(a) providing a solution of corn syrup in water;
(b) mixing gelatin with the solution from step (a) to provide a mixture;
(c) heating the mixture from step (b) to about 100° C. to provide a heated mixture, wherein the heated mixture contains a top layer and a bottom layer, or a single layer;
(d) cooling the heated mixture from step (c) to provide a mass; and
(e) optionally removing a top layer from the mass to provide the gelatin and corn syrup composite.

2. The gelatin and corn syrup composite of claim 1, wherein the gelatin is in a dry powder form.

3. The gelatin and corn syrup composite of claim 1, wherein the corn syrup and the gelatin are in a weight ratio ranging from 1.5:1 to 6:1.

4. The gelatin and corn syrup composite of claim 1, wherein the water and the gelatin are in a weight ratio ranging from 1.5:1 to 6:1.

5. The gelatin and corn syrup composite of claim 1, wherein the corn syrup and the gelatin are in a weight ratio ranging from 2.5:1 to 5:1.

6. The gelatin and corn syrup composite of claim 1, wherein the water, corn syrup and gelatin are in a weight ratio of about 3.5:2.8:1.

7. A method of preparing a gelatin and corn syrup composite, comprising the steps of:
(a) providing a solution of corn syrup in water;
(b) mixing gelatin with the solution from step (a) to provide a mixture;
(c) heating the mixture from step (b) to about 100° C. to provide a heated mixture, wherein the heated mixture contains a top layer and a bottom layer;
(d) cooling the heated mixture from step (c) to provide a mass; and
(e) removing a top layer from the mass to provide the gelatin and corn syrup composite.

8. The method of claim 7, wherein the gelatin is in a dry powder form.

9. The method of claim 7, wherein the corn syrup and the gelatin are in a weight ratio ranging from 1.5:1 to 6:1.

10. The method of claim 7, wherein the water and the gelatin are in a weight ratio ranging from 1.5:1 to 6:1.

11. The method of claim 7, wherein the corn syrup and the gelatin are in a weight ratio ranging from 2.5:1 to 5:1.

12. The method of claim 7, wherein the water, corn syrup and gelatin are in a weight ratio of about 3.5:2.8:1.

13. (canceled)

14. A toy set comprising at least one soft body robotic device, comprising:
(a) a flexible molded body having a plurality of interconnected chambers disposed within the molded body, and a strain limiting portion; and
(b) a pressurizing inlet configured to receive a gas for the plurality of interconnected chambers,
wherein the soft body robotic device is made of a gelatin and corn syrup composite, and the molded body is configured to preferentially expand when the plurality of interconnected chambers are pressurized by the fluid, causing a bending motion around the strain limiting portion.

15. The toy set of claim 14, further comprising a pressurizing device, and wherein the pressurizing inlet is configured to receive the pressurizing device.

16. (canceled)

17. A bubble gum product, comprising a gelatin and corn syrup composite prepared by a method of claim 7.

18. The bubble gum product of claim 17, wherein the gelatin and corn syrup composite is a sheet.
